(19) United States
(12) Patent Application Publication
(10) Pub. No.: US 2026/0187792 A1
(43) Pub. Date: Jul. 2, 2026

(54) MEDICAL IMAGE PROCESSING SYSTEM

(71) Applicant: Imvitec Corporation, Taipei City (TW)

(72) Inventors: Edward TSAI, Taipei City (TW); Shu-Wei HUANG, Taipei City (TW); Hui-Ya HUNG, Taipei City (TW)

(21) Appl. No.: 19/065,660

(22) Filed: Feb. 27, 2025

(30) Foreign Application Priority Data
Jan. 2, 2025 (TW) 114100159

(51) Int. Cl. G06T 7/00

(52) U.S. Cl. CPC G06T 7/0012; G06T 2207/20084; G06T 2207/30016; G06T 2207/30104

(57) ABSTRACT

A medical image processing system includes a medical image capture module, an AI model selection and execution module, a case sorting execution module, and a sorting condition setup module. The medical image capture module captures multiple medical image cases. The AI model selection and execution module displays an interface on the display device for selecting a specific AI model for performing an AI model operation with the medical image cases to generate one AI operation result for each medical image case. The case sorting execution module receives the AI operation results from the AI model selection and execution module. The sorting condition setup module displays a sorting condition setup interface on the display device for setting at least one sorting condition. The case sorting execution module compares and sorts the AI operation results according to the sorting conditions so as to generate a sorting result.

### CROSS REFERENCE TO RELATED APPLICATIONS

This Non-provisional application claims priority under 35 U.S.C. § 119(a) on Patent Application No(s). 114100159 filed in Taiwan, Republic of China on Jan. 2, 2025, the entire contents of which are hereby incorporated by reference.

### BACKGROUND

### Technology Field

The present disclosure relates to a medical image processing system capable of sorting medical image cases according to the severities of the patients'symptom.

### Description of Related Art

Medical imaging technology, such as CT (computed tomography) and MRI (magnetic resonance imaging), is an important tool for clinical diagnosis and treatment planning in modern medicine. CT uses X-rays along with computer processing to generate high-resolution cross-sectional images, which can be used to quickly identify fractures, bleeding, tumor size and distribution, and structural abnormalities of internal organs such as the brain, liver, and heart. MRI uses a strong magnetic field and radio frequency pulses (without radiation) to obtain clear contrast images of tissues. It is particularly suitable for observing lesions of cranial nerves, muscles, joints, ligaments and soft tissues, and accurately diagnosing brain tumors, central nervous system lesions, muscle and bone injuries or cardiovascular structures.

In the detection and staging of diseases, CT and MRI can be used to detect tiny lesions early, help determine the degree of local tumor infiltration and distant metastasis, and thus affect the choice of treatment strategies. In surgery planning, physicians can use the three-dimensional reconstruction results of CT or MRI to more accurately grasp the anatomical location of the surgical area, thereby improving the success rate and safety of the surgery. CT and MRI also play a key role in post-treatment follow-up, such as evaluating the extent of tumor shrinkage, the healing of surgically repaired tissues, and even monitoring changes in organ structure in chronic diseases. In addition, doctors can adjust treatment plans in real time based on regular imaging examinations so as to prevent potential complications.

Therefore, CT and MRI are indispensable in every stage of modern medicine. For example, in the stages of early screening, accurate diagnosis, treatment guidance, and follow-up tracking, they not only improve the accuracy of clinical decision-making, but also ensure the well-being of patients, thereby becoming an important cornerstone of contemporary medical quality.

As mentioned above, medical imaging technology is very important in clinical diagnosis and treatment planning. Therefore, hundreds of patients undergo CT and MRI almost every day in hospitals. The huge amount of medical images can cause a heavy burden on radiologists or specialists.

In recent years, with the rise of AI technology in medical imaging, more and more hospitals have begun to introduce AI-assisted interpretation for reducing the burden on doctors. However, AI technology in medical imaging is used for assisting interpretation, but it cannot completely replace radiologists or specialists in interpreting medical images. In particular, even with the assistance of AI technology in medical imaging, the radiologists or specialists still have to repeatedly confirm all of the patient's medical images due to medical responsibility and avoiding medical disputes.

As mentioned above, the use of AI technology in medical imaging to assist interpretation is a trend today. However, there are a large amount of medical images generated every day. If the AI technology in medical imaging can be used along with the sorting conditions made by the users (hospitals or doctors) for sorting dozens or even hundreds of medical image cases, the doctors can conduct manual interpretation on cases with higher rankings (e.g. those with more serious symptoms) and thus take appropriate medical treatments earlier.

### SUMMARY

An objective of this disclosure is to provide a medical image processing system that can sort the medical image cases according to the severities of the patients'symptoms.

To achieve the above, a medical image processing system of this disclosure is used in conjunction with a display device, and includes a medical image capture module, an AI model selection and execution module, a case sorting execution module, and a sorting condition setup module. The medical image capture module captures a plurality of medical image cases. The AI model selection and execution module is connected to the medical image capture module. The AI model selection and execution module displays an AI model selection and execution interface on the display device for a user to select a specific AI model, and uses the specific AI model to perform an AI model operation with each of the medical image cases to generate one AI operation result for each of the medical image cases. The case sorting execution module is connected to the AI model selection and execution module, and receives the AI operation results from the AI model selection and execution module. The sorting condition setup module is connected to the case sorting execution module, and displays a sorting condition setup interface on the display device for the user to set at least one sorting condition. The case sorting execution module compares and sorts the AI operation results according to the sorting conditions so as to generate a sorting result, and the sorting result is displayed on the display device.

In one embodiment, the medical image processing system further includes an interface display module connected to the medical image capture module, the AI model selection and execution module, the case sorting execution module, and the sorting condition setup module.

In one embodiment, the medical image capture module displays, through the interface display module, an image file retrieve button and an image file retrieve interface on the display device.

In one embodiment, the AI model selection and execution module displays, through the interface display module, an AI model selection and execution button and the AI model selection and execution interface on the display device.

In one embodiment, the case sorting execution module displays, through the interface display module, a case sorting execution button on the display device, and the sorting result is displayed, through the interface display module, on the display device.

In one embodiment, the sorting condition setup module displays, through the interface display module, a sorting condition setup button and the sorting condition setup interface on the display device.

In one embodiment, the AI model is an AI analysis module for brain medical image, and the sorting condition at least includes a size of brain tumor or a property of brain tumor.

In one embodiment, the AI model is an AI analysis model for brain vascular medical image, and the sorting condition at least includes a size of cerebral aneurysm or a presence of bleeding in a cerebral vessel.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic block diagram of a medical image processing system according to an embodiment of this disclosure;

FIG. 2 is a schematic diagram showing the display device displaying the medical image capture module of the medical image processing system according to the embodiment of this disclosure;

FIG. 3 is a schematic diagram showing the display device displaying the AI model selection and execution module of the medical image processing system according to the embodiment of this disclosure;

FIG. 4 is a schematic diagram showing the display device displaying the sorting condition setup module of the medical image processing system according to the embodiment of this disclosure;

FIG. 5 is a schematic diagram showing the display device displaying the sorting result generated by the case sorting execution module; and

FIG. 6 is a schematic diagram showing the display device displaying the first medical image case in the sorting result.

### DETAILED DESCRIPTION OF THE DISCLOSURE

The present disclosure will be apparent from the following detailed description, which proceeds with reference to the accompanying drawings, wherein the same references relate to the same elements.

Before describing the specific embodiments of the present disclosure, it should be noted that in the present disclosure, the term “electronic device” can refer to a device capable of operating AI models, such as a computing device, a computer, a server, or any device including the control operation unit (e.g. CPU or GPU), memory unit, and display card unit.

The term “medical image case” refers to the imaging files of medical images (e.g. CT, MRI, etc.) of the patient or examinee.

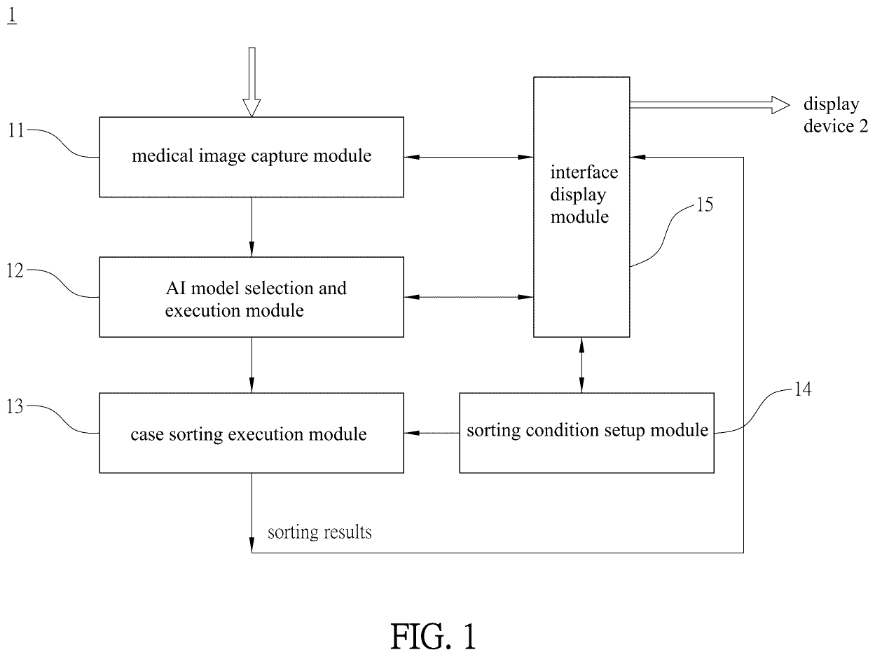

Referring to FIG. 1, a medical image processing system 1 of this disclosure is used in conjunction with a display device 2. The medical image processing system 1 includes a medical image capture module 11, an AI model selection and execution module 12, a case sorting execution module 13, a sorting condition setup module 14, and an interface display module 15.

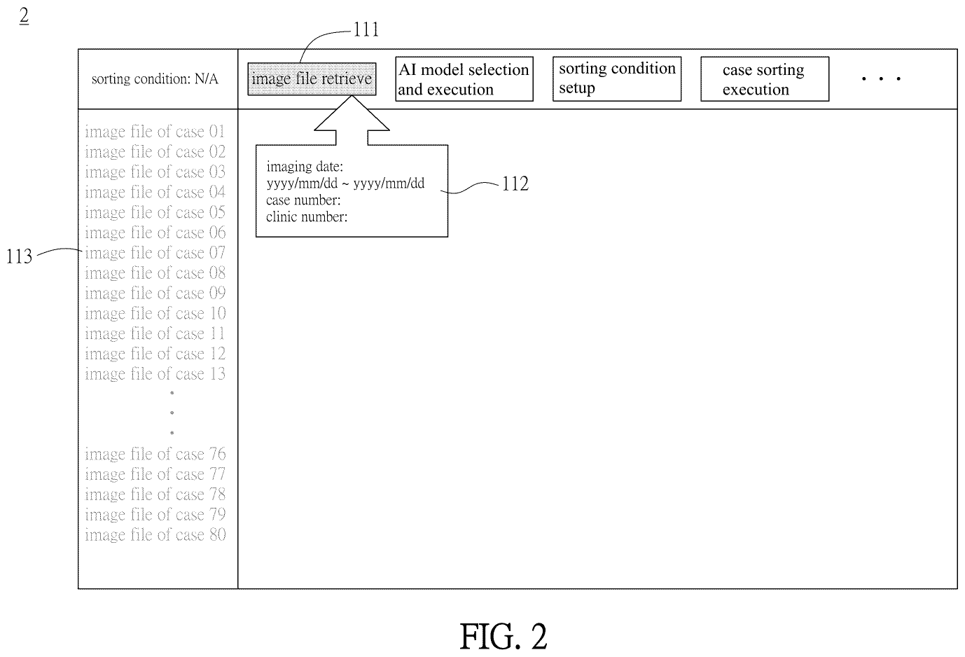

The user can uses the medical image capture module 11 to retrieve a plurality of medical image cases from the medical image system (e.g. PACS). As shown in FIG. 2, the medical image capture module 11 is connected to the interface display module 15, and displays, through the interface display module 15, an image file retrieve button 111 and an image file retrieve interface 112 on the display device 2. When the user clicks the image file capture button 111, an image file capture interface 112 may be shown on the display device 2. Then, the user may input the file import condition(s) to retrieve a plurality of medical image cases (files) 113, which are listed on the display device 2. In this embodiment, the file import conditions include, for example, imaging date period, clinic number, and/or case number. To be noted, in the present disclosure, the file import conditions are not limited thereto, and can be any conditions for importation. FIG. 2 shows 80 medical image cases 113 imported with taking the imaging date period as the import condition.

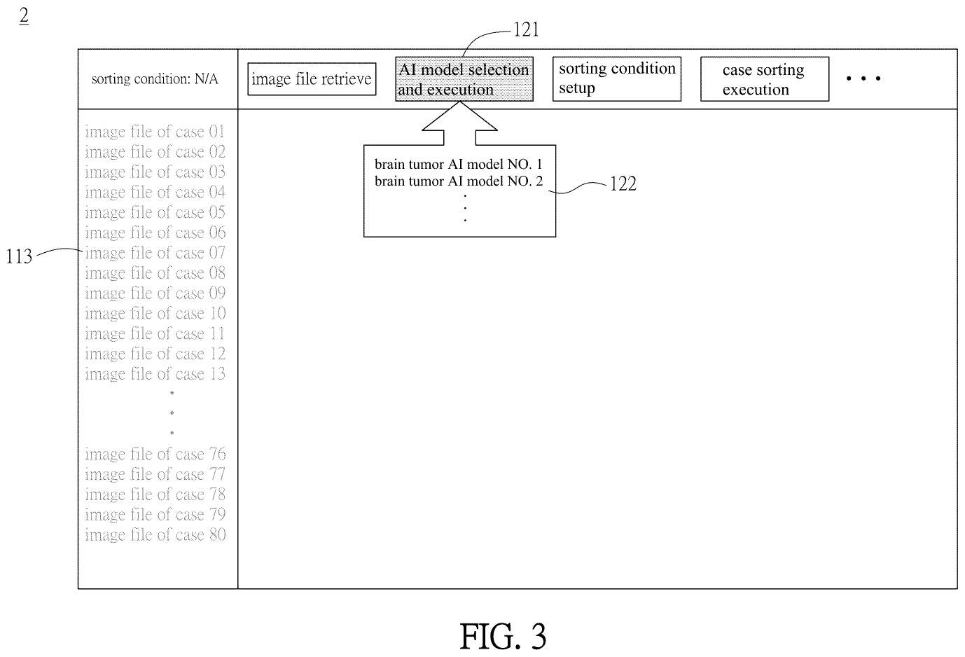

Referring to FIG. 1 in view of FIG. 3, the AI model selection and execution module 12 is connected to the medical image capture module 11 and the interface display module 15. Through the interface display module 15, an AI model selection and execution button 121 and an AI model selection and execution interface 122 can be displayed on the display device 2. When the user clicks the AI model selection and execution button 121, the AI model selection and execution interface 122 can be displayed on the display device 2 for the user to select a specific AI model (e.g. brain tumor AI model NO. 1 or brain tumor AI model NO. 2). The specific AI model is used to perform AI model operations on each medical image case, thereby generating an AI operation result for each medical image case. In this embodiment, the AI operation result includes information such as the size of brain tumor, the property of brain tumor (benign or malignant), or the likes. To be noted, different AI models may generate different AI operation results. Furthermore, the AI operation results of different AI models must be consistent with the sorting condition setup module 14.

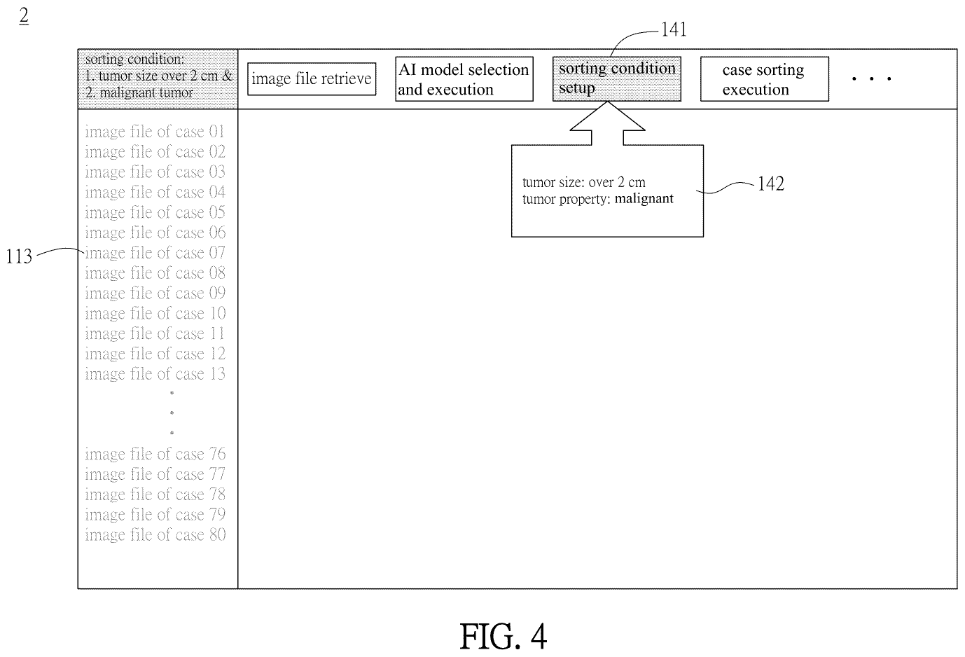

Referring to FIG. 1 in view of FIG. 4, the sorting condition setup module 14 is connected to the case sorting execution module 13 and the interface display module 15. The interface display module 15 can display a sorting condition setup button 141 and a sorting condition setup interface 142 on the display device 2 for the user to set at least one sorting condition. In this embodiment, for example, the setup conditions may include: the tumor size is greater than 2 cm, and the tumor is a malignant tumor. To be noted, if the selected specific AI model is an AI analysis model for brain vascular medical image (not shown), the sorting conditions for the AI analysis model for brain vascular medical image at least include the size of cerebral aneurysm, or whether a cerebral vessel is bleeding. In other words, in the present embodiment, the sorting condition can be changed according to the AI model selected by the user. To be noted, in the present disclosure, the sorting condition is not limited thereto, and any condition that can correspond to the operation result of the specific AI model can be referred to as a sorting condition in the present disclosure.

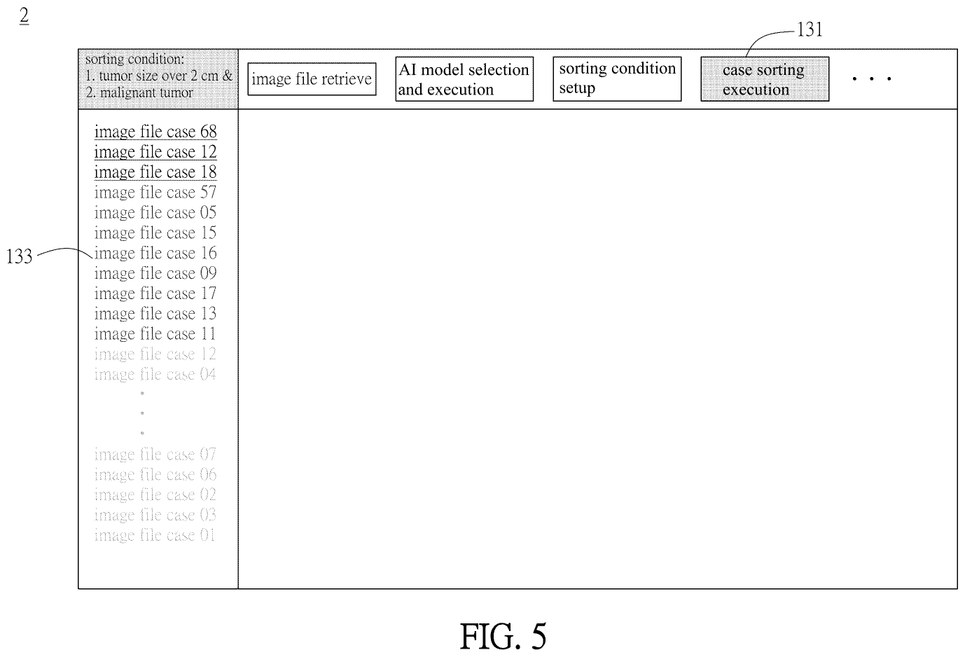

Referring to FIG. 1 in view of FIG. 5, the case sorting execution module 13 is connected to the AI model selection and execution module 12 and the interface display module 15, and a case sorting execution button 131 can be displayed on the display device 2 through the interface display module 15. When the user clicks the case sorting execution button 131, the case sorting execution module 13 receives the AI operation results from the AI model selection and execution module 12, and then compares and sorts the AI operation results according to the sorting conditions so as to generate a sorting result 133. The sorting result 133 can be displayed on the display device 2. The sorting results 133 as shown in FIG. 5 is the sorting results obtained based on the sorting conditions that the tumor size is greater than 2 cm and the tumor is a malignant tumor. For example, the image file of case 68, the image file of case 12, and the image file of case 18 marked with the underlines are the image files completely complying with the sorting conditions. The image file of case 57, the image file of case 05, the image file of case 15, the image file of case 16, the image file of case 09, the image file of case 17, the image file of case 13, and the image file of case 11 are the image files that do not completely comply with the sorting conditions. In addition, the other cases shown in light colors are the image files of completely normal cases.

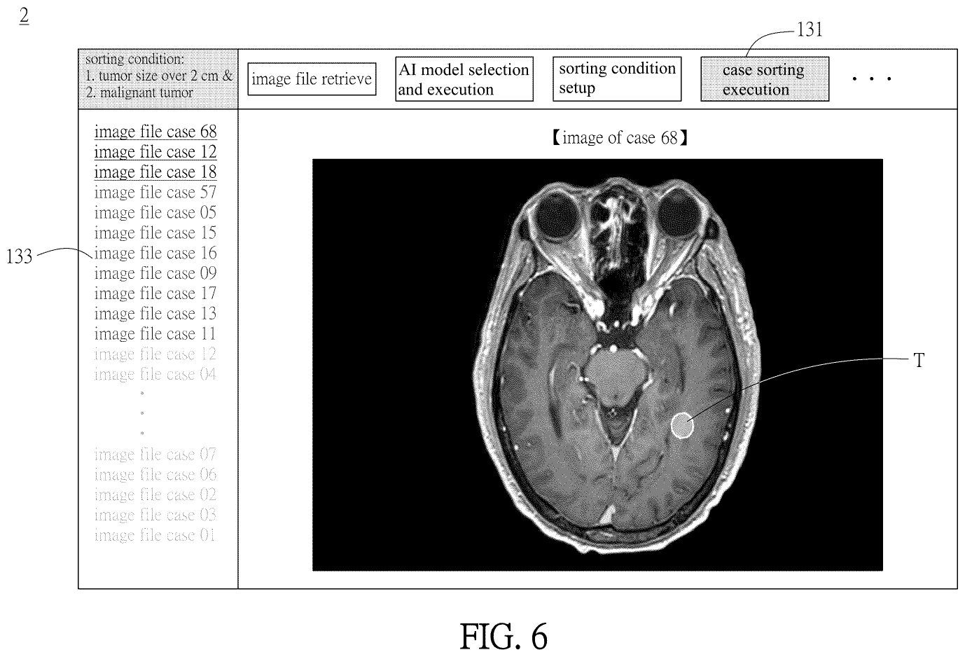

As mentioned above, as shown in FIG. 6, when the user clicks on the image file of case 68 marked with an underline, the case sorting execution module 13 can display the medical image of the image file of case 68 that comply with the sorting conditions on the display device 2 through the interface display module 15. For example, the brain tumor T shown in FIG. 6 has a tumor size larger than 2 cm and is a malignant tumor.

To be noted, the medical image processing system 1 of the present disclosure can be executed by an electronic device, and the interface display module 15 of this embodiment can be a part of the display card or display module of the electronic device. The aforementioned display device 2 is electrically connected to a display card of the electronic device.

In summary, the AI model selection and execution module uses the specific AI model selected by the user to perform an AI model operation with each of the medical image cases, and the case sorting execution module and the sorting condition setup module can sort the medical image cases according to the sorting conditions. Therefore, the user can first check the cases with relatively higher ranking in the sorting results. In other words, the user does not need to review each case one by one, but can process the priority cases with severe symptoms first. This can not only greatly reduce the workload of users (doctors), but also significantly reduce the risk of delaying treatment for cases with severe symptoms.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A medical image processing system, which is used in conjunction with a display device, comprising:
a medical image capture module capturing a plurality of medical image cases;
an AI model selection and execution module connected to the medical image capture module, wherein the AI model selection and execution module displays an AI model selection and execution interface on the display device for a user to select a specific AI model, and uses the specific AI model to perform an AI model operation with each of the medical image cases to generate one AI operation result for each of the medical image cases;
a case sorting execution module connected to the AI model selection and execution module, and receiving the AI operation results from the AI model selection and execution module; and
a sorting condition setup module connected to the case sorting execution module, and displaying a sorting condition setup interface on the display device for the user to set at least one sorting condition;
wherein, the case sorting execution module compares and sorts the AI operation results according to the sorting conditions so as to generate a sorting result, and the sorting result is displayed on the display device.

2. The medical image processing system of claim 1, further comprising:
an interface display module connected to the medical image capture module, the AI model selection and execution module, the case sorting execution module, and the sorting condition setup module.

3. The medical image processing system of claim 2, wherein the medical image capture module displays, through the interface display module, an image file retrieve button and an image file retrieve interface on the display device.

4. The medical image processing system of claim 2, wherein the AI model selection and execution module displays, through the interface display module, an AI model selection and execution button and the AI model selection and execution interface on the display device.

5. The medical image processing system of claim 2, wherein the case sorting execution module displays, through the interface display module, a case sorting execution button on the display device, and the sorting result is displayed, through the interface display module, on the display device.

6. The medical image processing system of claim 2, wherein the sorting condition setup module displays, through the interface display module, a sorting condition setup button and the sorting condition setup interface on the display device.

7. The medical image processing system of claim 1, wherein the AI model is an AI analysis module for brain medical image, and the sorting condition at least comprises a size of brain tumor or a property of brain tumor.

8. The medical image processing system of claim 1, wherein the AI model is an AI analysis model for brain vascular medical image, and the sorting condition at least comprises a size of cerebral aneurysm or a presence of bleeding in a cerebral vessel.
